(19) United States
(12) Patent Application Publication
(10) Pub. No.: US 2018/0308502 A1
(43) Pub. Date: Oct. 25, 2018

(54) METHOD FOR PROCESSING AN INPUT SIGNAL AND CORRESPONDING ELECTRONIC DEVICE, NON-TRANSITORY COMPUTER READABLE PROGRAM PRODUCT AND COMPUTER READABLE STORAGE MEDIUM

(71) Applicant: THOMSON Licensing, Issy-les-Moulineaux (FR)

(72) Inventors: Sanjeel PAREKH, Rennes (FR); Alexey OZEROV, Rennes (FR); Quang Khanh Ngoc DUONG, Rennes (FR); Gael RICHARD, Paris (FR); Slim ESSID, Cesson-Sevigne (FR); Patrick PEREZ, Rennes (FR)

(21) Appl. No.: 15/956,021

(22) Filed: Apr. 18, 2018

(30) Foreign Application Priority Data
Apr. 20, 2017 (EP) 17305456.0

(51) Int. Cl. G10L 21/028; G10L 25/57; G10L 21/0224; G10L 21/0232

(52) U.S. Cl. CPC G10L 21/028; G10L 21/0232; G10L 21/0224; G10L 25/57

(57) ABSTRACT

A method for processing an input signal having an audio component is described. The method includes obtaining a set of time parameters from a time frequency transformation of the audio component of the input signal, the audio component being a mixture of audio signals comprising at least one first audio signal of a first audio source; determining at least one motion feature of the first audio source from a visual sequence corresponding to the first audio signal; obtaining a weight vector of the set of time parameters based on the motion feature; and determining a time frequency transformation of the first audio signal based on the weight vector.

### REFERENCE TO RELATED EUROPEAN APPLICATION

This application claims priority from European Patent Application No 17305456.0, entitled “METHOD FOR PROCESSING AN INPUT SIGNAL AND CORRESPONDING ELECTRONIC DEVICE, NON-TRANSITORY COMPUTER READABLE PROGRAM PRODUCT AND COMPUTER READABLE STORAGE MEDIUM”, filed 20 Apr. 2017, the contents of which are hereby incorporated by reference in its entirety.

### TECHNICAL FIELD

The present disclosure relates to the field of signal processing, and notably to the field of processing of audio signals.

A method for processing an input signal and corresponding device, computer readable program product and computer readable storage medium are described.

### BACKGROUND

Audio enhancement, or audio denoising, plays a key role in many applications such as telephone communication, robotics, and sound processing systems. Numerous audio enhancement techniques have been developed such as those based on beamforming approaches or noise suppression algorithms. There also exists work in applying source separation for audio enhancement or for isolating an audio source from an audio mixture

There is need for a solution that permits enhancing the user experience of a device.

### SUMMARY

The present principles enable at least some disadvantages to be resolved by proposing a method for processing an input signal comprising an audio component.

According to an embodiment of the present disclosure, the method comprises:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

For instance, the time frequency transformation can be a spectrogram.

For instance, the time parameters can be time activations, like time activations extracted from a spectrogram. Such time activations can be representative of temporal fluctuations (or in other words fluctuations over at least one time interval) of an audio activity of the audio component.

The audio signal can notably result from a sound-producing motion of the first audio source and the visual sequence can notably correspond to the sound-producing motion of the first audio source.

Thus, according to at least one embodiment, the method comprises:
extracting a set of time activations from a spectrogram of said audio component of said input signal, said audio component being a mixture of audio signals comprising at least one first audio signal resulting from a sound-producing motion of a first audio source;
determining at least one motion feature of said first audio source from a visual sequence corresponding to said sound-producing motion;
estimating a weight vector of said set of time activations based on said motion feature; determining a spectrogram of said first audio signal based on said weight vector.

According to an embodiment of the present disclosure, said motion feature comprises a velocity and/or an acceleration of a sound-producing motion of a first audio source.

According to an embodiment of the present disclosure, said visual sequence is obtained from a video component of said input signal.

According to an embodiment of the present disclosure, said input signal and said visual sequence are obtained from two separate streams.

According to another aspect, the present disclosure relates to an electronic device adapted for processing an input signal comprising an audio component.

According to an embodiment of the present disclosure, said electronic device comprises at least one processor configured for:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

For instance, the time frequency transformation can be a spectrogram.

For instance, the time parameters can be time activations, like time activations extracted from a spectrogram. Such time activations can be representative of temporal fluctuations of an audio activity of the audio component.

The audio signal can notably result from a sound-producing motion of the first audio source and the visual sequence can notably correspond to the sound-producing motion of the first audio source.

Thus, according to at least one embodiment, said electronic device comprises at least one processor configured for:
extracting a set of time activations from a spectrogram of said audio component of said input signal, said audio component being a mixture of audio signals comprising at least one first audio signal resulting from a sound-producing motion of a first audio source;
determining at least one motion feature of said first audio source from a visual sequence corresponding to said sound-producing motion;
estimating a weight vector of said set of time activations based on said motion feature;
determining a spectrogram of said first audio signal based on said weight vector.

According to an embodiment of the present disclosure, said visual sequence is extracted from a video component of said input signal.

According to an embodiment of the present disclosure, said electronic device comprises at least one communication interface configured for receiving said input signal and/or said visual sequence.

According to an embodiment of the present disclosure, said electronic device comprises at least one capturing module configured for capturing said input signal and/or said visual sequence.

According to an embodiment of the present disclosure, said motion feature comprises a velocity and/or an acceleration of a sound-producing motion of the first audio source.

According to an embodiment of the present disclosure, said time frequency transformation of said audio component of said input signal is obtained by using jointly a Non-Negative Matrix Factorization (NMF) estimation and a Non-Negative Least Square (NNLS) estimation.

According to an embodiment of the present disclosure, estimating said weight vector comprises minimizing a cost function involving said motion feature, and said set of time parameters weighted by said weight vector.

According to an embodiment of the present disclosure, said cost function includes a sparsity penalty on said weight vector.

According to an embodiment of the present disclosure, the sparsity penalty forces a plurality of elements in said weight vector to zero.

While not explicitly described, the communication device of the present disclosure can be adapted to perform the method of the present disclosure in any of its embodiments.

According to another aspect, the present disclosure relates to an electronic device comprising at least one memory and at least one processing circuitry adapted for processing an input signal comprising an audio component.

According to an embodiment of the present disclosure, said at least one processing circuitry is adapted for:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

According to an embodiment of the present disclosure, said at least one processing circuitry is adapted for:
extracting a set of time parameters from a time frequency transformation of said audio component of said input signal, said audio component being a mixture of audio signals comprising at least one first audio signal resulting from a sound-producing motion of a first audio source;
determining at least one motion feature of said first audio source from a visual sequence corresponding to said sound-producing motion;
estimating a weight vector of said set of time parameters Ha based on said motion feature;
determining a time frequency transformation of said first audio signal based on said weight vector.

While not explicitly described, the electronic device of the present disclosure can be adapted to perform the method of the present disclosure in any of its embodiments.

According to another aspect, the present disclosure relates to a communication system comprising an electronic device of the present disclosure in any of its embodiments.

While not explicitly described, the present embodiments related to a method or to the corresponding electronic device or communication system can be employed in any combination or sub-combination.

For example, some embodiments of the method of the present disclosure can involve extracting said video sequence from a video component of said input signal, said input signal being received from at least one communication interface of the electronic device implementing the method of the present disclosure.

According to another aspect, the present disclosure relates to a non-transitory program storage product, readable by a computer.

According to an embodiment of the present disclosure, said non-transitory computer readable program product tangibly embodies a program of instructions executable by a computer to perform the method of the present disclosure in any of its embodiments.

According to an embodiment of the present disclosure, said non-transitory computer readable program product tangibly embodies a program of instructions executable by a computer for performing, when said non-transitory software program is executed by a computer, a method for processing an input signal comprising an audio component, said method comprising:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

According to an embodiment of the present disclosure, said non-transitory computer readable program product tangibly embodies a program of instructions executable by a computer for performing, when said non-transitory software program is executed by a computer, a method for processing an input signal comprising an audio component, said method comprising:
extracting a set of time parameters from a time frequency transformation of said audio component of said input signal, said audio component being a mixture of audio signals comprising at least one first audio signal resulting from a sound-producing motion of a first audio source;
determining at least one motion feature of said first audio source from a visual sequence corresponding to said sound-producing motion;
estimating a weight vector of said set of time parameters based on said motion feature;
determining a time frequency transformation of said first audio signal based on said weight vector.

According to another aspect, the present disclosure relates to a computer readable storage medium carrying a software program comprising program code instructions for performing the method of the present disclosure, in any of its embodiments, when said non-transitory software program is executed by a computer.

According to an embodiment of the present disclosure, said computer readable storage medium tangibly embodies a program of instructions executable by a computer for performing, when said non-transitory software program is executed by a computer, a method for processing an input signal comprising an audio component, said method comprising:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

According to an embodiment of the present disclosure, said computer readable storage medium tangibly embodies a program of instructions executable by a computer for performing, when said non-transitory software program is executed by a computer, a method for processing an input signal comprising an audio component, said method comprising:
extracting a set of time parameters from a time frequency transformation of said audio component of said input signal, said audio component being a mixture of audio signals comprising at least one first audio signal resulting from a sound-producing motion of a first audio source;
determining at least one motion feature of said first audio source from a visual sequence corresponding to said sound-producing motion;
estimating a weight vector of said set of time parameters based on said motion feature;
determining a time frequency transformation of said first audio signal based on said weight vector.

### BRIEF DESCRIPTION OF THE DRAWINGS

The present disclosure can be better understood, and other specific features and advantages can emerge upon reading the following description, the description making reference to the annexed drawings wherein:

FIG. 1 is a pictorial example illustrating an example where a spectrogram V is decomposed into two matrices W and H;

FIG. 2 illustrates an embodiment of the method of the present disclosure performed;

FIG. 3 illustrates an exemplary structure of a communication device adapted to perform the method of the present disclosure; and

FIG. 4 illustrates a block diagram of a system adapted to perform the method of the present disclosure.

It is to be noted that the drawings illustrate exemplary embodiments and that the embodiments of the present disclosure are not limited to the illustrated embodiments.

### DETAILED DESCRIPTION

Different aspects of an event occurring in the physical world can be captured using different sensors. The information obtained from at least one sensor can be used to disambiguate noisy information obtained from at least another sensor, based on the correlations that exist between both information. Such information is sometimes referred to hereinafter as a modality.

For instance, if considering a scene of a busy street or a music concert, what is heard is a mix of sounds coming from multiple sources (or objects) like a car, a bus, a person in a street or an instrument or a singer in a concert. Visual information, in terms of movement of these sources over time, can be very useful for decomposing an audio mixture and for associating those sources with their respective audio streams. Indeed, often, there exists a correlation between sounds and the motion responsible for the production of those sounds. For instance, motion of the mouse of a baby that is crying can be correlated with the sound of the crying. Thus, some embodiments using a joint analysis of audio and motion can permit to improve computation of at least one modality which will be otherwise difficult.

In the exemplary embodiments detailed hereinafter, we are interested in correlating audio and motion modalities. Notably, information correlated with sound-producing motion can be used to perform the challenging task of single channel audio source separation.

Of course, the principle of the present disclosure can be used in a variant in other embodiments involving other modalities (for instance speech and text) which can be correlated.

Audio source separation technique deals with decomposing an audio mixture into constituent sound sources. Some audio source separation algorithms have been developed to distinguish a contribution of at least one audio source in an input mixture signal gathering contributions of several audio sources. Such algorithms can permit to isolate a first signal from a mixture signal (for speech enhancement or noise removal for instance). Such algorithms are often based on non-negative matrix factorization (NMF).

Motion information that can be used for guiding the task of audio source separation can be extracted from video sequence(s).

The present disclosure proposes a novel and inventive approach with fundamental differences with existing studies. Notably, at least some embodiments propose to regress motion features such as velocity using temporal activations of audio components. Intuitively, this means coupling of physical excitation for sound production (represented though motion features such as velocity) with audio spectral component activations (also called herein time activations). As it will be explained in more details hereinafter, this can be modeled for instance as nonnegative least squares or a Canonical Correlation Analysis (CCA) problem in an NMF-based source separation framework.

FIG. 3 describes the structure of an electronic device 30 configured notably to perform the method of the present disclosure that is detailed hereinafter.

The electronic device can be an audio and/or video signal acquiring device, like a smart phone or a camera. It can also be a device without any audio and/or video acquiring capabilities but with audio and/or video processing capabilities. In some embodiment, the electronic device can comprise a communication interface, like a receiving interface to receive an audio and/or video signal, like an input signal to be processed according to the method of the present disclosure. This communication interface is optional. Indeed, in some embodiments, the electronic device can process audio and/or video signals, like signals stored in a medium readable by the electronic device, received or acquired by the electronic device.

In the exemplary embodiment of FIG. 3, the electronic device 30 can include different devices, linked together via a data and address bus 300, which can also carry a timer signal. For instance, it can include a micro-processor 31 (or CPU), and/or a graphics card equipped with a Graphic Processing Unit (GPU) 310. Depending on embodiments, such a graphic card may be optional. The electronic device 30 can also include at least one Input/Output module 34, (like a keyboard, a mouse, a led, and so on), a ROM (or «Read Only Memory») 35, a RAM (or «Random Access Memory») 36. In the exemplary embodiment of FIG. 3, the electronic device can further comprise at least one communication interface 37, 38 configured for the reception and/or transmission of data, notably audio and/or video data, a power supply 39. This communication interface is optional. The communication interface can be a wireless communication interface 37 (notably of type WIFI® or Bluetooth®) or a wired communication interface 38.

In some embodiments, the electronic device 30 can also include, or be connected to, a display module 33, for instance a screen, directly connected to the graphics card 32 by a dedicated bus 330. Such a display module can be used for instance to output at least one video stream obtained by the method of the present disclosure (comprising a video sequence related to the sound-producing motion correlated to the audio source S1) and notably a video component of the input signal.

In some embodiments, like in the illustrated embodiment, the electronic device 30 can communicate with another device thanks to a wireless interface 37.

Each of the mentioned memories can include at least one register, that is to say a memory zone of low capacity (a few binary data) or high capacity (with a capability of storage of an entire audio and/or video file notably).

When the electronic device 30 is powered on, the microprocessor 31 loads the program instructions 360 in a register of the RAM 36, notably the program instruction needed for performing at least one embodiment of the method described herein, and executes the program instructions.

According to a variant, the electronic device 30 includes several microprocessors. According to another variant, the power supply 39 is external to the electronic device 30.

In the exemplary embodiment illustrated in FIG. 3, the microprocessor 31 can be configured for processing an input signal.

According to an embodiment of the present disclosure, said microprocessor 31 can be configured for:
obtaining a set of time parameters from a time frequency transformation of an audio component of said input signal, said audio component being a mixture of audio signals comprising at least one first audio signal resulting from a first audio source;
determining at least one motion feature of said first audio source from a visual sequence corresponding to said first audio signal;
obtaining a weight vector of said set of time parameters s based on said motion feature; and

determining a time frequency transformation of said first audio signal based on said weight vector.

According to an embodiment of the present disclosure, said microprocessor 31 can be configured for:
extracting a set of time activations from a spectrogram of an audio component of said input signal, said audio component being a mixture of audio signals comprising at least one first audio signal resulting from a sound-producing motion of a first audio source;
determining at least one motion feature of said first audio source from a visual sequence corresponding to said sound-producing motion;
estimating a weight vector of said set of time activations based on said motion feature;
determining a spectrogram of said first audio signal based on said weight vector.

As will be appreciated by one skilled in the art, aspects of the present principles can be embodied as a system, method, or computer readable medium. Accordingly, aspects of the present disclosure can take the form of a hardware embodiment, a software embodiment (including firmware, resident software, micro-code, and so forth), or an embodiment combining software and hardware aspects that can all generally be referred to herein as a “circuit”, module” or “system”. Furthermore, aspects of the present principles can take the form of a computer readable storage medium. Any combination of one or more computer readable storage medium(s) may be utilized.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing.

It is to be appreciated that the following, while providing more specific examples of computer readable storage mediums to which the present principles can be applied, is merely an illustrative and not exhaustive listing as is readily appreciated by one of ordinary skill in the art: a portable computer diskette, a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

Thus, for example, it will be appreciated by those skilled in the art that the block diagrams presented herein represent conceptual views of illustrative system components and/or circuitry of some embodiments of the present principles. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown.

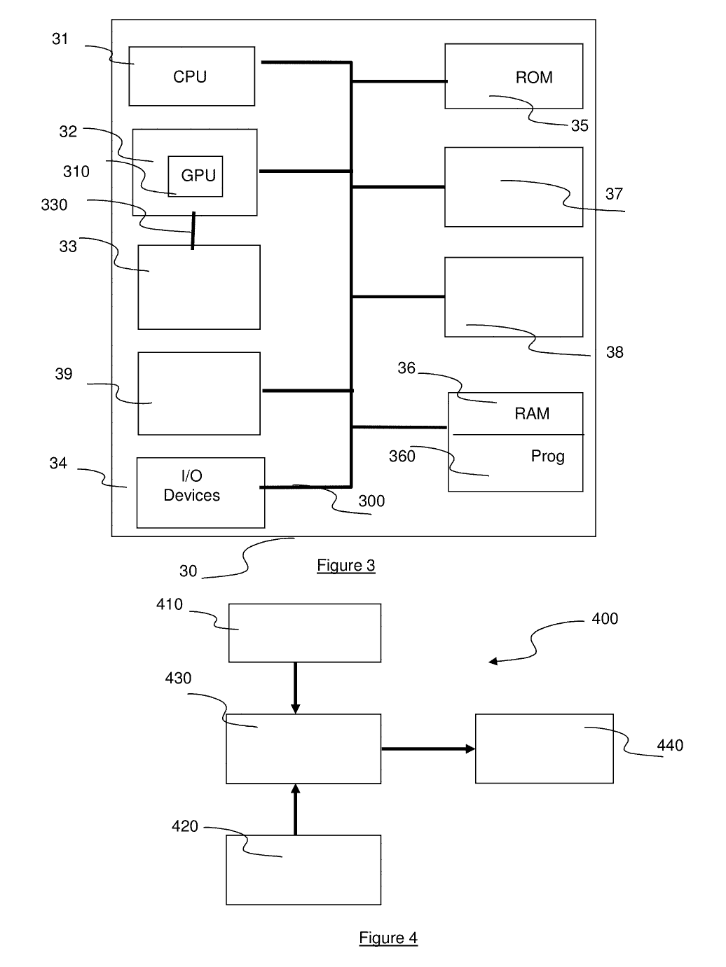

FIG. 4 depicts a block diagram of an exemplary system 400 where an audio separating module can be used according to an embodiment of the present principles.

Microphone 410 records an audio mixture (for instance a noisy audio mixture) that needs to be processed. The microphone may record audio from one or more audio sources, for instance one or more music instruments. The audio input can also be pre-recorded and stored in a storage medium.

At the same time, a camera 420 records a video sequence of a motion associated to at least one of the audio source. As the audio input, the video sequence can also be pre-recorded and stored in a storage medium.

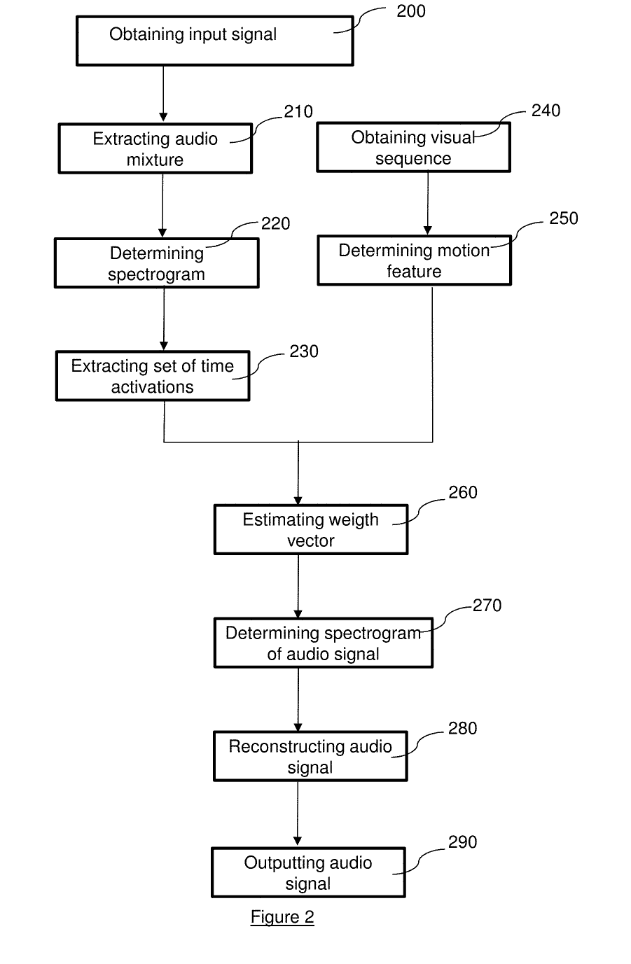

Given the audio mixture, audio source separation module 430 may obtain spectral model and time activations for at least one source associated with motion, for example, using method illustrated by FIG. 2. It can then deliver an output audio signal corresponding to the at least one source associated with motion and/or reconstruct an enhanced audio mixture based on the input audio mixture but with a different balance between sources for instance. The reconstructed or delivered audio signal can then be played by a speaker, like the speaker 440. The output audio signal may also be saved in a storage medium, or can be provided as input to another module.

Different modules shown in FIG. 4 may be implemented in one device, as illustrated by FIG. 3, or distributed over several devices. For example, all modules may be included in a tablet or mobile phone. In another example, audio enhancement module 430 may be located separately from other modules, in a computer or in the cloud. In yet another embodiment, camera module 420 as well as Microphone 410 can be a standalone module from audio separating module 430.

FIG. 2 illustrates an exemplary embodiment of the method of the present disclosure.

According to the embodiment of FIG. 2, the method comprises obtaining 200 an input signal. Depending upon embodiments, the input signal can be of audio type or can also comprise a video component. For instance, in the exemplary embodiment described, the input signal is an audiovisual signal, comprising an audio component being a mixture of audio signals, one of the audio signals being produced by a motion made by a first source, and a video component comprising a capture of this motion. According to the illustrated embodiment, where the input stream in an audiovisual stream, comprising at least one audio component and at least one video component, the method can also comprise extracting 210 the audio mixture from the input signal. Of course, this step can be optional in embodiments where the input signal only contains audio component(s). The method can also comprise obtaining 240 a visual sequence of the sound producing motion. In some embodiments, the visual sequence can be obtained, for instance by extracting the visual sequence from the input signal as shown in FIG. 2. In other embodiments, the visual sequence can be obtained separately to the input signal.

In some embodiments, the input signal and/or the corresponding video signal can be received from a distant device, thanks to at least one communication interface of the device in which the method is implemented. In other embodiments, the input signal and/or the corresponding video signal can be read locally from a storage medium readable from the device in which the method is implemented, like a memory of the device or a removable storage unit (like a USB key, a compact disk, and so on). In still other embodiments, the input signal and/or the corresponding video signal an be acquired thanks to acquiring means, like a microphone, a camera, or a web cam. Depending upon embodiments, a source of motion can be diverse. For instance, the source of motion can be fingers of a person or a mouth of a person (notably a speaker or a baby), facing a camera capturing the motion. The source of motion can be also a music instrument, like a bow interacting with strings of a violin, or an apparatus (notably a vehicle, a mechanical or electronic device, etc.). The audio produced by the source of motion can be captured by a microphone. Both signals captured by the camera and the microphone can be stored, separately or jointly, for a later processing and/or transmitted to a processing module of the device implementing the method of the present disclosure.

According to FIG. 2, the method can also comprise determining 220 a spectrogram of the audio mixture. For instance, in the illustrated embodiment, the determining can comprise transforming the audio mixture via Short-time Fourier Transform (STFT) into a time-frequency representation being a spectrogram matrix (denoted herein after X) being complex valued (i.e. containing both magnitude and phase parts), and extracting a spectrogram matrix Vₐ related to the magnitude part of the complex valued spectrogram matrix X. The determined matrix Vₐ can be for example, power (square magnitude) or magnitude of the STFT coefficients.

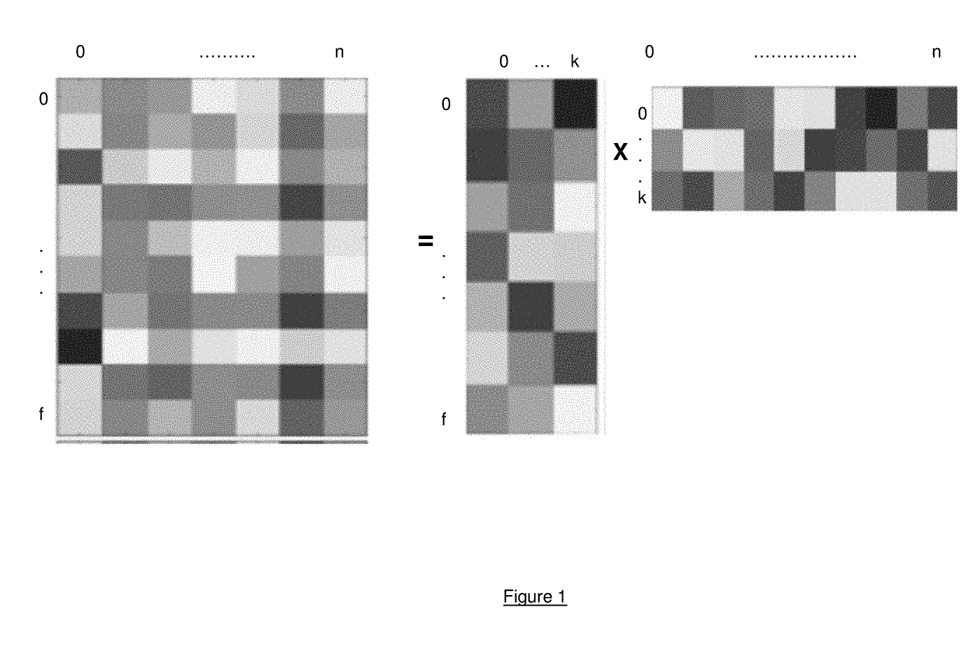

In the illustrated embodiment, the method can comprise extracting 230 a set of time activations from the determined spectrogram. For instance, the non-negative spectrogram matrix Vₐ of dimension F×N can be decomposed into two non-negative matrices, Wₐ (the spectral model of dimension F×K) and Hₐ (time activations of dimension K×N), such that Vₐ≈\hat{V}ₐ=WₐHₐ. In this formulation, F denotes the total number of frequency bins, N denotes the number of time frames, and K denotes the number of spectral components, wherein a spectral component corresponds to a column in the matrix Wₐ and represents a latent spectral characteristic. Wₐ and Hₐ can be interpreted as the latent spectral features and the activations of those features in the signal, respectively. FIG. 1 provides an example where a spectrogram V is decomposed into two matrices Wₐ and Hₐ.

A magnitude spectrogram or power spectrogram of an audio mixture of j sources (=Σⱼ₌₁^{J}sⱼ) can be factorized as a multiplication of two non-negative matrices, i.e. Vₐ≈WₐHₐ, as illustrated by FIG. 1. Rows of Hₐ can be interpreted as temporal activation vectors for the corresponding spectral component in the columns of Wₐ.

When the input is a mixture of two sources, we may write matrix Wₐ=[Wₐ₁, Wₐ₂], where the matrix Wₐ contains spectral components of, for example, first source S1 (Wₐ₁) from which the sound providing motion is originating, and the remaining part of the audio component of the input signal (Wₐ₂). Such a remaining part can include, for instance the contribution of at least one other source, and/or noise like ambient noise for instance. Similarly, the activation matrix Ha also includes two parts: Hₐ=[Hₐ₁;Hₐ₂], where Hₐ₁ and Hₐ₂ correspond respectively to the activation matrix of the first source S1 and the remaining part of the audio component of the input signal.

Hₐ₁ and Hₐ₂ are matrices representing time activations, which indicate whether a spectral component is active or not at each time index and can be considered as weighting the contribution of spectral components to the spectrogram, corresponding to Wₐ₁ and Wₐ₂, respectively. Once the decomposition is obtained, the spectrogram of the first source S1 is estimated as Vₐ₁=Wₐ₁Hₐ₁, and the spectrogram of the remaining part of the audio component of the input signal (for instance a second audio source S2) as Vₐ₂=Wₐ₂Hₐ₂.

The problem then is to cluster the right set of spectral components for reconstructing each source. At least some embodiments of the present disclosure propose to use features extracted from the sound-producing motion to do so. Consider for instance a string quartet performance, intuitively, the physical excitation of a string with the bow (which can be extracted with features such as bow velocity) should be similar to a combination of some audio spectral component activations of the mixture that correspond to the produced sound.

In the detailed embodiment, it is assumed that every audio source of the audio part of the input signal can be associated with a sound producing motion. In other embodiments, however the audio part of the input signal can be a mixture of sounds originating from at least one source of sound-producing motion and sounds (like ambient noise) originating from at least one source not associated with a sound-producing motion.

Thus, herein we attempt to determine a linear combination, αⱼ of audio activations that best reconstructs the magnitude of velocity of a moving object, j. With the I₂ error minimization criterion this reduces to a nonnegative least squares problem where we look for αⱼ that best reconstructs the magnitude of velocity of a moving object, j. We could also determine αⱼ such that the correlation is maximized. This amounts to solving a CCA problem. We explore both of these approaches below. The coefficients of αⱼ (or in other words the weights of αⱼ) are representative of the importance of a spectral component's time activations for reconstructing the motion vector. We can thus use the coefficients of αⱼ to cluster appropriate spectral components for reconstructing each source in the mixture. In parallel or sequentially relatively of the extracting 210 of the audio mixture, the determining 220 of the spectrogram and/or the extracting 230 of the set of time activations, the method can comprise determining 250 motion features from the obtained visual sequence. For instance, the motion feature can include a velocity and/or an acceleration related to the corresponding sound producing motion.

According to the illustrated embodiment, the method can comprise, once the set of time activations has been extracted and the motion feature determined, estimating 260 a weight vector, representative of the weights to be associated with the set of time activations to obtain the activation matrix H_{S1} corresponding to sound originating from the audio source S1.

Different ways of estimating the weight vector can be used, depending on the embodiments. Some exemplary ways of estimating the weight vector are described hereinafter, in an exemplary purpose.

The following notations are used for ease of explanations:
K: Number of basis vectors
J: Total number of audio sources
Vₐ≈WₐHₐ where Wₐ=(w_{a,fk})_{f,k}∈R₊^{F×K} and Hₐ=(h_{a,kn})_{k,n}∈R₊^{K×N} are interpreted as the non-negative audio spectral patterns and their activation matrices respectively.
vⱼ∈R₊^{N}: Motion feature vector for each source j∈{1,J}, as an example it can be velocity magnitude extracted from the video sequence
M∈R₊^{N×J}: Motion matrix with each motion feature vector arranged into columns as [v₁ v₂ . . . vⱼ]
A∈R₊^{K×J}: Non-negative weight matrix for taking linear combinations of Hₐ, with each column denoted by αⱼ where j∈{1,J}

It is to be pointed out that for the above notation it is assumed, for ease of explanations, that the total number of velocity vectors is equal to the total number of sources J. However, multiple velocity vectors per source can be easily incorporated as explained later.

According to some embodiments, estimating the weight vector can comprise using a Non-Negative Least Squares (NNLS) approach, or by a similar approach.

In such an embodiment, the decomposition of motion in audio activations is considered to be linear. Unlike some previous work, like the work of Parkeh et al (Parekh, S., Essid, S., Ozerov, A., Duong, N., Perez, P., and Richard, G. (2017). Motion informed audio source separation. In IEEE International Conference on Acoustics, Speech and Signal Processing (ICASSP 2017)), where the activations were supplied, at least some embodiments of the present disclosure propose to learn a linear combination of audio activations that best represents the velocity vector, vⱼ of a given object (or source), j.

Formally, we want to determine a non-negative weight vector αⱼ∈R₊^{K×1} such that ∥vⱼ−Hₐ^{T}αⱼ∥ is minimized. The magnitude of the weight vector indicates the importance of a time activation vector, Hₐ_{ₖ} in the reconstruction. This can be implemented in different ways. For instance, according to some embodiments, NNLS is performed after performing NMF on the audio mixture.

In NNLS, for each audio source j∈{1,J}, the objective is to determine a non-negative weight vector αⱼ that best reconstructs each source's velocity vector given the audio time activations Hₐ extracted by NMF.

According to other embodiments, after extracting the audio time activations of the audio mixture by NMF, the velocity vector for each source is factorized using the audio time activations extracted from the audio mixture as the basis vectors. As only a few audio activations should contribute to form the source's velocity, we expect the linear combination weight vector α to be sparse.

Hence, we solve the following optimization problem:

$${minimize }_{α} {‖ M - {H}_{α}^{T} A ‖}_{2}^{2} + μ {‖ A ‖}_{1} \qquad ( 1 )$$

This can be looked at as a sparse NMF problem with the basis vectors (here Hₐ^{T}) held constant. Depending upon embodiments, the resolution of the sparse NMF can be performed differently. Notably, as an examplar, it can be based on a technique disclosed by Le Roux et all (Le Roux, J., Weninger, F., and Hershey, J. R. (2015). “Sparse NMF—half-baked or well done?”).

According to still other embodiments, instead of doing the sparse NMF after audio factorization, audio factorization and sparse NMF are done jointly. We can formulate for instance the following cost function that includes a divergence function D which can be, in some embodiments, Kullback-Leibler divergence here the motion and time activations are coupled using I₂ norm with sparsity on A through the I₁ norm:

$$C ( {W}_{a} , {H}_{a} , A ) = {D}_{KL} ( {V}_{a} \vert {W}_{a} {H}_{a} ) + \frac{λ}{2} {‖ M - {H}_{a}^{T} A ‖}_{2}^{2} + μ {‖ A ‖}_{1} \qquad ( 2 )$$

In other embodiments, one could consider using other beta divergences.
At least one embodiment proposes to minimize the cost function: C(γWₐ,Hₐ/γ,Aγ)<C(Wₐ,Hₐ,A) where γ is close to zero.
Therefore, we constrain the columns of Wₐ to have unit norm i.e. we construct

$$= [ \frac{{w}_{a , 1}}{‖ {w}_{a , 1} ‖} \frac{{w}_{a , 2}}{‖ {w}_{a , 2} ‖} … \frac{{w}_{a , K}}{‖ {w}_{a , K} ‖} ]$$

and incorporate this into the cost function as:

$${minimize}_{{W}_{a} , {H}_{a} , A} {D}_{KL} ( {V}_{a} \vert {H}_{a} ) + \frac{λ}{2} {‖ M - {H}_{a}^{T} A ‖}_{2}^{2} + μ {‖ A ‖}_{1} \qquad ( 3 )$$

In some embodiments, the following multiplicative updates can be derived for the iterative optimization of the cost function explained above.

In some embodiments, the following algorithm can be derived for the iterative optimization of the cost function explained above.

To avoid confusion and clutter we use Λ = WₐHₐ. Product ⊙ and exponents
denote element-wise operations, 1 denotes a matrix with all entries
equal to one and size given by context.
Algorithm I Joint NMF-Sparse NNLS

| | | |
|---|---|---|
| 1: | Input: Vₐ, M, K, λ ≥ 0, μ ≥ 0 | |
| 2: | Wₐ, Hₐ, A initialized randomly | |
| 3: | Hₐ ← diag(∥wₐ₁∥, . . . , ∥w_{aK}∥)Hₐ | |
| 4: | A ← diag(∥wₐ₁∥⁻¹, . . . , ∥w_{aK}∥⁻¹)A | |
| 5: | Wₐ ← Wₐdiag(∥wₐ₁∥⁻¹, . . . , ∥w_{aK}∥⁻¹) | [symbol] Normalize |
| 6: | Λ = WₐHₐ | |
| 7: | repeat | |
| 8: | ${H}_{a} ← {H}_{a} ⊙ \frac{{{W}_{a}}^{⊤} ( {V}_{a} ⊙ {Λ}^{- 1} ) + λ {AM}^{⊤}}{{{W}_{a}}^{⊤} 1 + λ {AA}^{⊤} {H}_{a}}$ | |
| 9: | Λ = WₐHₐ | |
| 10: | ${W}_{a} ← {W}_{a} ⊙ \frac{( {Λ}^{- 1} ⊙ {V}_{a} ) {{H}_{a}}^{⊤} + {W}_{a} ⊙ ( 1 ( {W}_{a} ⊙ ( 1 {{H}_{a}}^{⊤} ) )}{1 {{H}_{a}}^{⊤} + {W}_{a} ⊙ ( 1 ( {W}_{a} ⊙ ( ( {Λ}^{- 1} ⊙ {V}_{a} ) {{H}_{a}}^{⊤} ) ) )}$ | |
| 11: | Wₐ ← Wₐdiag(∥wₐ₁∥⁻¹, . . . , ∥w_{aK}∥⁻¹) | |
| 12: | Λ = WₐHₐ | |
| 13: | $A ← A ⊙ \frac{λ {H}_{a} M}{λ {H}_{a} {{H}_{a}}^{⊤} A + μ}$ | |
| 14: | until convergence | |
| 15: | return Wₐ, Hₐ, A | |

In a variant, in some embodiments, that differ from the embodiments already described based on a NNLS approach, the method comprises determining a linear transformation αⱼ that maximizes the correlation between motion and the audio activation matrix. This technique termed as canonical correlation analysis is equivalent to minimizing the following cost function:

$$\frac{‖ {v}_{j} - {H}_{a}^{T} {α}_{j} ‖}{{‖ {H}_{a}^{T} {α}_{j} ‖}_{2} + {‖ {v}_{j} ‖}_{2}} \qquad ( 7 )$$

The differences between least squares and CCA are easily seen from the equation above. Like in the previously detailed embodiments, the minimizing can be done sequentially or jointly. In the following, CCA is performed after audio factorization. Hence for each vⱼ we determine an αⱼ for j∈{1,J}. Here A is obtained by stacking αⱼ's determined after running CCA independently for each velocity vector vⱼ. Since the coefficients could take on negative values too we consider their magnitude, |αₖⱼ|.

According to FIG. 2, the method also comprises determining 270 a spectrogram of the audio signal correlated to the motion of the first source S1, by using the weight vector and/or the corresponding activation matrix H_{S1}.

In some embodiments, for instance for cases where intensity of motion might differ, the method can comprise normalizing α₁. This step is optional.

In the exemplary embodiment illustrated, once the spectrogram of the audio signal originated from the audio source S1 has been obtained, the method can comprise reconstructing 270 the audio signal produced by the motion made by the source S1. This step is optional. Notably, in some embodiments, the spectrogram of the audio signal (of the source S1) can be stored on a storage medium and/or transmitted to another device for a later reconstruction or for other processing (like for audio identification).

In the detailed embodiment, with the notation already used hereinbefore, once we obtain A, which contains α₁ for each of the J sources, A can be interpreted and used for source reconstruction in multiple ways.

For instance, in some embodiments, the method can comprise the following strategy for using αₖⱼ: a basis vector k is assigned to the source [symbol] if

$${j}^{′} = {arg max}_{j} {α}_{kj} .$$

Once these assignments are made, each source is reconstructed by multiplying the soft mask (Wₐ_{ⱼ}Hₐ_{ⱼ}/WₐHₐ) with the complex spectrogram X obtained from the audio mixture.

In some embodiments, the method can further comprise inverting the spectrogram to get to the time domain.

In some embodiments, the method can be applied to multiple velocity vectors associated with at least one source of motion. Indeed, a region of a moving object (for instance a hand of a musicien) can often be associated with multiple motion trajectories. Most of techniques already explained can be applied as it is to the multiple velocity vector case, except that the source reconstruction strategy. Hence, considering the case where each source contains Tⱼ trajectories and they are stacked in the columns of M, A would then be a K×T_{J} matrix where

$${T}_{j} = {\sum }_{j = 1}^{J} {T}_{j} .$$

We use a similar strategy as above wherein we choose the column (i.e. a velocity trajectory) containing the maximum value of alpha for each spectral component. This spectral component is simply assigned to the source from whose region that trajectory was extracted.

The method can also comprise further steps that can be optional depending upon embodiments. For instance, the method can comprise reconstructing 280 at least one audio signal based on its determined psectrogramme. Notably, in an embodiment where the audio mixture comprises sound originating from at least one source not associated with a sound-producing motion (for instance when the audio mixture contains noise), we may need to de-noise a source j in the presence of noise. In such an embodiment, the method can comprise processing αⱼ by considering for reconstruction only a subset of the αⱼ coefficients, like the coefficient having values being above a given threshold and/or a given number of values, for instance the i coefficients having the highest values (let's say the top i) amongst the αⱼ coefficients.

In the exemplary embodiment of FIG. 2, the method can comprise outputting 290 the audio signal originated from the audio source S1. Term “outputting” is herein to be understood in its broadest meaning and can include many diverse processing, like storing the reconstructed audio signal on a storage medium, transmitting the audio signal to a distant device, and/or rendering the audio signal of at least one loudspeaker.

The present principles of the present disclosure have been detailed above regarding one audio source of a sound producing motion. Of course, the principles of the present disclosure can also apply to an audio component of input signal being an audio mixture comprising more than two audio signals coming from two or more audio sources of sound-producing motion, a video stream being associated with those two or more audio sources, in order to separate all or part of those two or more audio sources from the audio mixture. In some embodiments, a single video stream containing a video sequence of all sound-producing motions of the two or more audio sources can be used. In other embodiments, several video streams, each containing a video sequence of some of the sound-producing motions of the two or more audio sources, can be used. For instance, in some embodiments, a different video stream can be associated with each audio source.

The present principles can notably be used in an audio separating module that denoises an audio mixture to enhance the quality of the reproduction of audio, and the audio separating module can be used as a pre-processor or post-processor for other audio systems.

In the embodiment detailed above, it has been assumed for ease of explanation that both the audio part of the input signal and the video sequence corresponding to the sound producing module are synchronized (or in other words temporally aligned).

In a variant, some embodiments of the method of the present disclosure can take into account a delay between a motion and the corresponding sound, as a motion would occur before a corresponding sound is emitted and as propagation times of audio and video are different. In such an embodiment, a delay can be incorporated into the cost function.

Segregating sound of multiple sounding objects into separate streams or from ambient sounds using at least one embodiment of the present disclosure can find useful applications for user-generated videos, audio mixing or enhancement and even robots with audio-visual capabilities.

For instance, technique explained above can be used to perform audio source separation and/or onscreen sounding object denoising.

At least some embodiments of the present disclosure can be adapted to process “on the fly” audio and/or video input signal and/or to already recorded videos. Indeed, it is possible to estimate a velocity vector from the motion trajectories using optical flow or other moving object segmentation/tracking approaches in a recorded video.

Specifically, one can imagine many real-life example/scenarios where at least some embodiments of the present disclosure can be useful. For instance, at least some embodiments of the present disclosure can be applied to videos captured through smartphones during any event such as a concert or to a broadcast concert or a show that is rendered on a television set. Indeed, it is often desirable to remove the ambient noise. Moreover, a user might be interested in enhancing or separating a source of audio (for instance a vocalist or a violinist from the rest of a group of audio sources).

At least some embodiments of the present disclosure can be applied to sound/film production scenarios where engineers look to separate audio streams (for upmixing for instance).

At least some embodiment of the present disclosure notably permit to avoid restriction on the number of audio basis vectors when factorizing. Furthermore, in at least some embodiments, the approach of the present disclosure is independent of specific inputs such as bow inclination, eliminating the need to provide a pre-constructed motion activation matrix.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that some feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for processing an input signal comprising an audio component, said method comprising:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

2. The method of claim 1 wherein said motion feature comprises a velocity and/or an acceleration of a sound-producing motion of said first source.

3. The method of claim 1 wherein said visual sequence is obtained from a video component of said input signal.

4. The method of any of claim 1 wherein said input signal and said visual sequence are obtained from two separate streams.

5. The method of claim 1 wherein said time frequency transformation of audio component of said input signal is obtained by using jointly a Non-Negative Matrix Factorization (NMF) estimation and a Non-Negative Least Square (NNLS) estimation.

6. The method of claim 1 wherein estimating said weight vector comprises minimizing a cost function involving said feature and said set of time parameters weighted by said weight vector.

7. The method of claim 6 wherein said cost function includes a sparsity penalty on said weight vector.

8. The method of claim 7 wherein the sparsity penalty forces a plurality of elements in said weight vector to zero.

9. An electronic device for processing an input signal comprising an audio component, said electronic device comprising at least one processor configured for:
obtaining a set of time parameters from a time frequency transformation of an audio component of said input signal, said audio component being a mixture of audio signals comprising at least one first audio signal resulting from a first audio source;
determining at least one motion feature of said first audio source from a visual sequence corresponding to said first audio signal;
obtaining a weight vector of said set of time parameters s based on said motion feature; and
determining a time frequency transformation of said first audio signal based on said weight vector.

10. The electronic device of claim 9 wherein said motion feature comprises a velocity and/or an acceleration of a sound-producing motion of said first source.

11. The electronic device of claim 9 wherein said visual sequence is obtained from a video component of said input signal.

12. The electronic device of claim 9 wherein said input signal and said visual sequence are obtained from two separate streams.

13. The electronic device of claim 9 wherein said time frequency transformation of audio component of said input signal is obtained by using jointly a Non-Negative Matrix Factorization (NMF) estimation and a Non-Negative Least Square (NNLS) estimation.

14. The electronic device of claim 9 wherein estimating said weight vector comprises minimizing a cost function involving said feature and said set of time parameters weighted by said weight vector.

15. The electronic device of claim 14 wherein said cost function includes a sparsity penalty on said weight vector.

16. The electronic device of claim 15 wherein the sparsity penalty forces a plurality of elements in said weight vector to zero.

17. The electronic device of claim 9 wherein said electronic device comprises at least one communication interface configured for receiving said input signal and/or said visual sequence.

18. The electronic device of claim 9 wherein said electronic device comprises at least one capturing module configured for capturing said input signal and/or said visual sequence.

19. A non-transitory computer readable program product comprising program code instructions for performing, when said non-transitory software program is executed by a computer, a method for processing an input signal comprising an audio component, said method comprising:
obtaining a set of time parameters from a time frequency transformation of said audio component of said input signal, said audio component being a mixture of audio signals comprising at least one first audio signal of a first audio source;
determining at least one motion feature of said first audio source from a visual sequence corresponding to said first audio signal;
obtaining a weight vector of said set of time parameters based on said motion feature; and
determining a time frequency transformation of said first audio signal based on said weight vector.

20. A computer readable storage medium carrying a software program comprising program code instructions for performing, when said non-transitory software program is executed by a computer, the method according to claim 1.
